(19) United States
(12) Patent Application Publication
(10) Pub. No.: US 2004/0160952 A1
(43) Pub. Date: Aug. 19, 2004

(54) Apparatus and method for facilitating communications

(75) Inventors: Michael Borella, Naperville, IL (US); Sundar Raman, Arlington Heights, IL (US)

Correspondence Address: FITCH EVEN TABIN AND FLANNERY, 120 SOUTH LA SALLE STREET, SUITE 1600, CHICAGO, IL, 60603-3406, US

(73) Assignee: 3Com Corporation

(21) Appl. No.: 10/369,093

(22) Filed: Feb. 18, 2003

(51) Int. Cl. H04L 12/66

(52) U.S. Cl. 370/355; 370/401

(57) ABSTRACT

A wireless gateway (10) (such as, for example, a packet data serving node) as comprises a part of a first wireless communication system (11) and having an external interface (12) that permits coupling to an extranet (61) can further have, in a preferred embodiment, an integral, native layer 2 linking protocol capability (13). So configured, the wireless gateway can serve to facilitate, for a mobile node (63) user of the first wireless communication system, both wireless communications via the first wireless communication system and wireless communications via a second, different wireless communication system (62). In one embodiment, the first wireless communication system comprises a CDMA2000-compatible system and the second wireless communication system comprises an 802.11-compatible system.

### TECHNICAL FIELD

This invention relates generally to wireless communications.

### BACKGROUND

Wireless communications are well known in the art and encompass both voice and data communications. Typically a given mobile node will be adapted and configured to operate compatibly within a given predetermined wireless communications system. For example, a given cellular telephone will usually be configured to operate within a given corresponding cellular telephony system by technically ensuring that the cellular telephone utilizes a correct carrier (or carriers), modulation type, channel spacing, signaling protocol, and the like. In addition, such a cellular telephone will also typically be pre-authorized to use the services of the cellular telephone system as well.

For a variety of reasons, there area a plurality of wireless communications systems in use with many of these systems having either technological differences that distinguish one from the other and/or other enterprise distinctions (including business-related barriers). These circumstances in turn present a potential for stranding a given mobile node without service if and when that mobile node roams to an area where compatible service is literally unavailable and/or otherwise commercially denied.

One prior art development has been the proliferation of roaming agreements between differing system providers whereby the user of one system will be granted service on another system when within range of that other system. Another prior art development has been the creation of multi-platform mobile nodes that are selectively agile with respect to various technological requirements to assure compatible operation on varying systems.

Data communications present a particular challenge in this regard. Data communications can be supported by, for example, CDMA2000 networks and also by, for example, 802.11 networks. CDMA2000 networks can, when properly comported, support either relatively low speed and/or high speed network access. Roaming between such CDMA2000 networks can be supported relatively well and relatively aggressive mobility on the part of the communicating mobile node can also usually be supported relatively well. Unfortunately, such systems are costly (particularly when one considers both equipment acquisition and installation as well as carrier frequency acquisition). 802.11 networks, by contrast, will support very high speed network access and present at least the possibility of considerably reduced infrastructure expenses as compared, for example, to CDMA2000 network solutions. 802.11 networks, however, are typically viewed as being more-or-less limited to relatively small so-called hot-spots where coverage is available (owing in part to low power limitations and also to the relatively unsupervised nature of the frequency bands that have been allotted for such services). Such 802.11 networks are therefore not always useful for a mobile node that will not remain within range of the network point of access for the duration of a given communication.

Given that both of the suggested networks have strengths and weaknesses, a mobile node that will work compatibly with both such systems has been proposed. The notion, of course, would be to use at any given moment whichever network choice makes the most sense (using whatever decision criteria is important to a given user, such as cost of access, mobility considerations, and so forth). Unfortunately, at present, while such a two-radios-in-one-box platform can be provided, there exists little opportunity for synergistic exploitation of such a platform due in part to a present lack of facilitating economical and reliable communication between such systems. Such a dual-platform mobile node, at present, must typically comprise an independently authorized user of both such systems in order to assure service availability of both.

### BRIEF DESCRIPTION OF THE DRAWINGS

The above needs are at least partially met through provision of the apparatus and method for facilitating communications described in the following detailed description, particularly when studied in conjunction with the drawings, wherein:

FIG. 1 comprises a block diagram as configured in accordance with an embodiment of the invention;

FIG. 2 comprises a prior art schematic illustration of a layer 2 tunneling protocol;

FIG. 3 comprises a prior art schematic illustration of an attribute-value pair format as used with layer 2 tunneling protocol;

FIG. 4 comprises a prior art schematic illustration of a control packet format as used with layer 2 tunneling protocol;

FIG. 5 comprises a prior art schematic illustration of data packet format as used with layer 2 tunneling protocol;

FIG. 6 comprises a block diagram as configured in accordance with an embodiment of the invention;

FIG. 7 comprises a flow diagram as configured in accordance with an embodiment of the invention;

FIG. 8 comprises a call flow diagram as configured in accordance with an embodiment of the invention; and

FIG. 9 comprises a call flow diagram as configured in accordance with another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, a wireless access gateway can facilitate user communications for a first system user via a first wireless communication system as sourced by that user from within the first wireless communication system and can also facilitate user communications for that first system user via the second wireless communication system as sourced by that user from within the second wireless communication system. In one embodiment, the wireless access gateway comprises a packet data serving node that comprises a part of the first communication system and which further includes an extranet interface and a layer 2 tunneling protocol platform integrally disposed therewith.

In a preferred embodiment, this packet data serving node has a mode of operation such that the layer 2 tunneling protocol supports a communication via the extranet interface. So configured, the packet data switching node can facilitate the user communications as specified above for a first wireless communication system user which is within the second wireless communication system.

In one embodiment, the first wireless communication system comprises a CDMA2000-compatible communication system and the second wireless communication system comprises an 802.11-compatible wireless communication system.

So configured, it can be seen that a single wireless access gateway can facilitate wireless communications for users of a first system via at least both a first wireless communication system and a second wireless communication system.

In a preferred approach, information resources within the first wireless communications system can be accessed to facilitate the wireless communication via the second wireless communication system. For example, the information can be such as to aid in authenticating the user as a first wireless communication system user.

In a preferred approach, at least some accounting information can be maintained as regards wireless communications that are facilitated for such a first system user via a second wireless communication system.

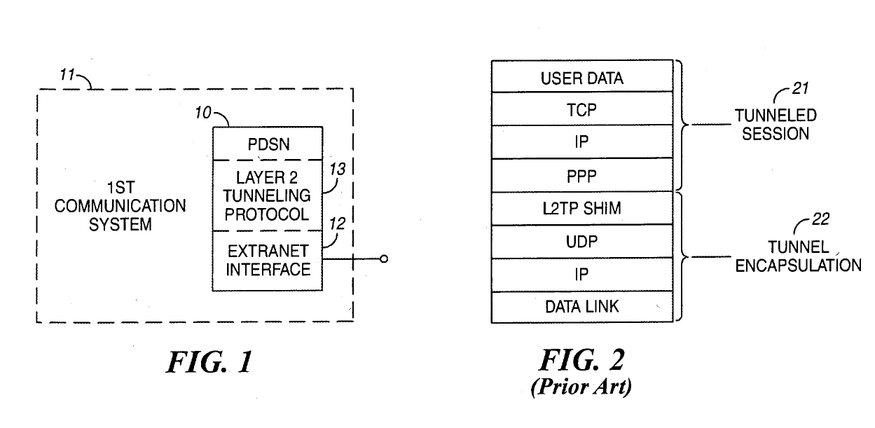

Referring now to the drawings, and in particular to FIG. 1, a packet data serving node 10 as comprises a part of a first communication system 11 as is otherwise well understood in the art also includes an extranet interface 12 and a layer 2 tunneling protocol platform disposed integrally therewith. The extranet interface 12 comprises an interface as appropriate to couple compatibly to an extranet of choice (such interfaces are well understood in the art and hence additional detail will not be provided here for the sake of brevity and the preservation of focus).

The layer 2 tunneling protocol (L2TP) comprises a rapidly evolving mechanism that enables automatic tunneling between dialup users and a private network. L2TP can also be used to establish a virtual private network between two distinct Internet protocol (IP) networks that are connected by a third public network. Unlike simple IP-in-IP tunneling, L2TP:

encapsulates an entire PPP session within an X/IP/UDP (where “X” refers to a data-link protocol and “UDP” refers to the user datagram protocol) session;

allows for negotiation of session parameters via a virtual control channel;

provides sequence numbers and retransmission mechanisms for reliability, flow control, and congestion control; and

is extensible via user-defined extension headers.

An example L2TP protocol stack for encapsulation of a TCP session over an IP network is shown in FIG. 2. The tunneled session 21 consists of user data in a PPP/IP/TCP packet (it being understood that such a packet formation serves an illustrative purpose here, as other formations could be utilized as well; for example, the packet could also be PPP/IP/UDP or X/IP/Y). This packet is tunnel encapsulated 22 by an IP/IDP packet between an L2TP shim header at the beginning of the UDP payload and a data link layer. The shim header provides tunnel and session identification as well as a version number, sequence numbers, and other control information as well understood in the art.

In ordinary L2TP usage, a dialup user will often dial into an Internet service provider. The Internet service provider access router will then serve as an L2TP access concentrator (LAC) and establish an L2TP tunnel on behalf of the user to an L2TP network server (LNS) at a private Internet provider network. The LAC can determine the endpoint of the tunnel from either the user's authentication profile or E.164 phone number. The LAC tunnels the user's point-to-point protocol session to the LNS, which removes the L2TP and serves as a virtual access concentrator, terminating the user's point-to-point protocol session. The LNS may also authenticate the user and provide him or her with an Internet protocol address from the private network's address space. To the user it will seem as if they are directly connected to the private network. In this way an employee can, for example, telecommute to a remote office.

There are other approaches as well. For example, pursuant to a second approach, an organization owns two private networks that are connected to the Internet. The LAC in the first private network initiates and maintains an L2TP tunnel to the LNS at the second private network. All traffic between the private networks is then transparently tunneled over the Internet via this channel.

Such LAC and LNS functionality is usually implemented on top of an existing router or access concentrator (modem pool) architecture. In many cases, the LNS (and perhaps the LAC) will be implemented as part of a firewall.

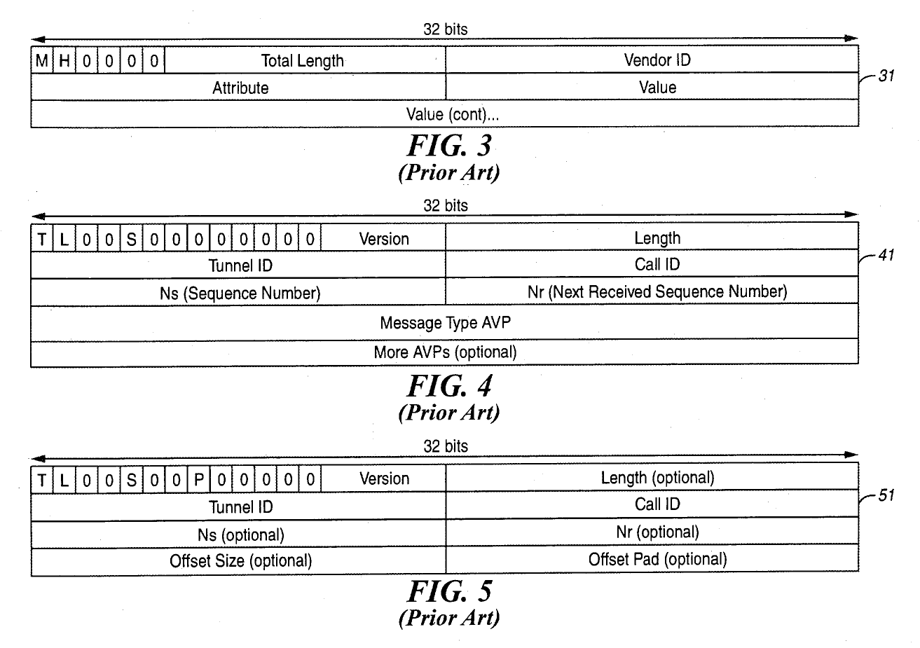

In order to ensure flexibility and extensibility, L2TP utilizes an attribute-value pair (AVP) format within its control packets. An AVP defines an attribute and its associated value. A single control packet may contain one or more AVPs. FIG. 3 illustrates a typical 32 bit format 31 for such an AVP, wherein the depicted fields have the following values:

M: Mandatory bit. Determines the behavior of a call or tunnel when the LAC or LNS receives an AVP that it does not recognize. If M is set on an unrecognized AVP associated with an individual session (call), the session will terminate. If M is set on an unrecognized AVP associated with the tunnel, the entire tunnel will be terminate. If M is 0, the LAC or LNS will ignore an unrecognized AVP. In general, a session or tunnel is terminated with the M bit only if the unrecognized AVP is critical to the type of communication that will occur.

H: Hidden bit. Controls the “hiding” of the value field. When an LAC and LNS have a shared secret, they may encrypt sensitive data, such as passwords, by performing an MD5 hash on the data (MD5 being a known algorithm developed by Professor Ronald Rivest of MIT and being typically used to verify data integrity). When such a hash has been performed, the H bit is set.

Total length: The total number of bytes in the AVP.

Vendor ID: For AVPs defined by a private vendor, the vendor will place its Internet Assigned Numbers Authority-assigned vendor ID code here. This allows extensibility and vendor-specific features.

Attribute: A code for the actual attribute, which must usually be unique with respect to the vendor ID.

Value: Encodes a value for the attribute. The length of this field is equal to the value of the total length field minus six.

Referring now to FIG. 4, L2TP control packets 41 usually comprise a 12-bye header followed by a Message Type AVP. Zeros or more optional AVPs then usually follow the latter. The depicted control packet fields have the following values:

T: Indicates a control packet. Must ordinarily be set.

L: Indicates that the length field is present. Must ordinarily be set.

S: Indicates that the sequence number fields are present. Must ordinarily be set for control packets.

Version: Must be “2,” indicating L2TP.

Length: Total length of the control packet, including header and all AVPs.

Tunnel ID: Numeric tunnel identifier. Set to zero if tunnel is yet to be established.

Call ID: Numeric call identifier. Set to zero if call is yet to be established.

Ns: This packet's sequence number.

Nr: The next packet's sequence number.

Nr: The next sequence number that the sender expects to receive a packet with from the receiver.

Message type AVP: An AVP describing the type of this message.

Note that within the limits of the tunnel's maximum transmission unit (MTU) (which, as is well-known in the art, defines the largest packet size in bytes that a tunnel can transmit without high risk of fragmentation), as many AVPs as desired can be appended to control packets.

Referring now to FIG. 5, data packets 51 within L2TP have the format depicted, wherein the indicated fields have the following values:

T: Indicates a data packet. Must be zero.

L: Is set when the optional length field is present.

S: Is set when the optional sequence number fields are present.

O: Is set when the offset size field is present.

P: If set, this packet should be treated preferentially by the recipient.

Version: Must be 2, indicating L2TP.

Length: Total length of the control packet, including header and all AVPs

Tunnel ID: Numeric tunnel identifier. Set to zero if tunnel is yet to be established.

Call ID: Numeric call identifier. Set to zero if call is yet to be established.

Ns: This packet's sequence number.

Nr: The next sequence number that the sender expects to receive a packet with from the receiver.

Offset size: The number of bytes past the L2TP header at which the payload begins.

Offset pad: Should be set to zeros.

Tunnel establishment is typically accomplished via a three-way handshake of control messages. The LAC sends a Start-Control-Connection-Request (SCCRQ) message. The LNS responds with a Start-Control-Connection-Reply (SCCRP) message. The LAC completes the handshake with a Start-Control-Connection-Connected (SCCCN) message. These messages are also used to exchange information about basic operating capabilities of the LAC and LNS, as defined by standardized AVPs. Each of these messages can contain extension functionality with the use of additional AVPs.

In a TCP/IP network, the LNS default listen port is 1701. A tunnel is established when an LAC transmits a UDP packet (usually an SCCRQ) to the LNS listen port. The LAC and LNS may continue to communicate using port 1701, or may change their transmit and listen ports dynamically. Once a tunnel has been established, calls may originate from either the LAC or the LNS.

An L2TP tunnel can be torn down from either the LAC or LNS with the transmission of a Stop-Control-Connection-Notification (StopCCN) message. The recipient of a StopCCN message terminates all calls within the tunnel and cleans up the tunnel state. No acknowledgement of or response to the StopCCN is sent to the originator of the message.

This layer 2 tunneling protocol is a preferred approach to facilitating the communications described herein, but it should be understood to also serve an illustrative purpose as well, as other mechanisms and protocols, now know or hereafter developed, would no doubt suffice as well.

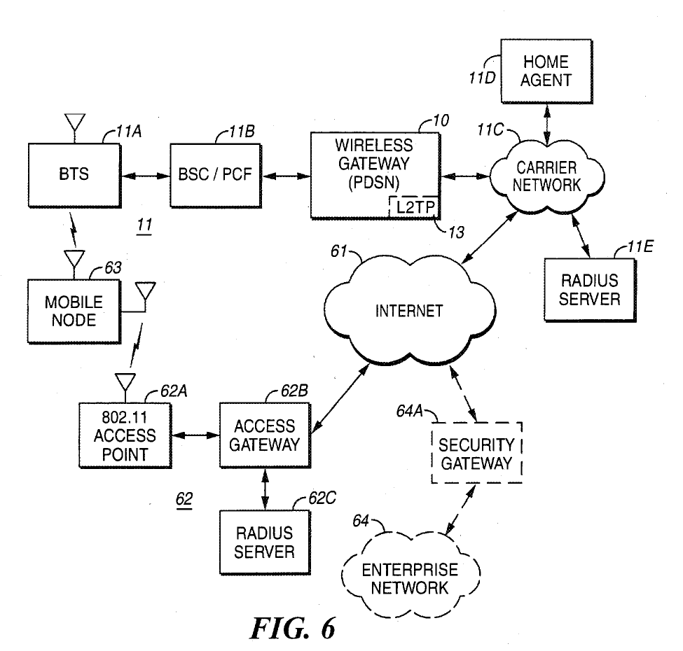

Referring now to FIG. 6, an illustrative architectural embodiment will be described. A first wireless communication system 11 comprises, in this embodiment, a CDMA2000-compatible communication system as is known in the art. This system 11 includes at least one (and typically many) base transceiver station (BTS) 11A that couples to a corresponding base station controller (BSC) 11B. In this embodiment, and as otherwise well understood in the art, the base station controller 11B further serves as a Packet Control Function (PCF), which PCFs are known in the art. So configured, the BSC/PCF 11B can readily couple and communicate with a wireless gateway, preferably such as the packet data switched node 10 described above. The latter 10 couples to the first wireless communication system's Internet protocol backbone 11C to thereby gain access to both a home agent (HA) 11D and, in this embodiment, a home RADIUS server 11E as well. (A fully operational system of this type of course ordinarily includes other commonly understood components and functionality. The latter are not especially pertinent to an understanding of this embodiment, however, and therefore are not presented for the sake of clarity and the preservation of focus.) So configured, this first wireless communication system 11 can provide CDMA2000-compatible wireless communications to, for example, a compatible mobile node 63 as well understood in the art. A mobile node 63 can readily contact the first wireless communication system 11 via an in-range base transceiver station 11A. The mobile node 63 can then indicate its communication needs and receive appropriate authorizations via the packet data serving node 10, again as understood in the art.

FIG. 6 also depicts another wireless communication system 62 comprising, in this embodiment, an 802.11-compatible system. For purposes of this illustration, this second wireless communication system 62 includes an 802.11 wireless access point 62A that couples to the Internet 61 via an access gateway 62B. This second system 62 also includes, in this embodiment, a RADIUS server 62C that couples to the access gateway 62B. So configured, the second wireless communication system 62 can provide 802.11-compatible services to the mobile node 63 (where, for purposes of this embodiment, the mobile node 63 itself further comprises an 802.11-compatible platform). In accordance with ordinary prior art practice, of course, such 802.11 service would ordinarily be denied to the mobile node 63 by the second wireless communication system 62 unless and until the mobile node 63 registers in some fashion with the second wireless communication system 62.

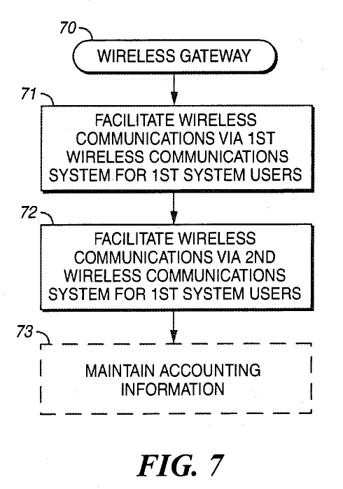

Pursuant to these embodiments, however, the mobile node 63 can effect wireless communications via either the first or second wireless communication systems 11 and 62 while only being a registered user of the first system 11 (it should be understood that these teachings are also applicable in a situation where the mobile node is pre-registered with both systems if so desired). The wireless gateway 10 of the first wireless communication system 11 facilitates such results. With momentary reference to FIG. 7, a process 70 for the wireless gateway permits the wireless gateway to facilitate 71 wireless communications via the first wireless communication system 11 for first system users (such as, in the above examples, the mobile node 63). The wireless gateway can also facilitate 72 wireless communications via the second wireless communication system 62 for the same class of first system user (such as, again, the mobile node 63 referenced above).

In particular, in this embodiment, the packet data serving node 10 can facilitate CDMA2000-compatible wireless communications via the first wireless communication system 11 and 802.11-compatible wireless communications via the second wireless communication system 62 for an authenticated user of the first system 11 regardless of whether that user is also previously associated with the second system 62. Additional exemplary details are provided below where appropriate.

With continued momentary reference to FIG. 7, optionally, the wireless gateway 10 can also maintain accounting information regarding such communications (as effected using either the first or second wireless communication system 111 or 62). For example, and without intending to provide an exhaustive listing, the packet data serving node 10 can maintain history regarding any or all of the following informational illustrations:

a local Internet Protocol address as assigned to a first system user as corresponds to a given wireless communication as facilitated via the second wireless communications system;

identifying information for a corresponding second wireless communications system access point;

identifying information for a corresponding second wireless communication system access point channel;

information corresponding to signal propagation performance for the second wireless communications system as corresponds to the given wireless communication;

a hardware address as corresponds to the first system user;

information as provided by a dynamic host configuration protocol (DHCP) server as corresponds to the given wireless communication; and/or

a geographic location of the first system user.

Any or all of these (or other) accounting attributes can be coded in L2TP AVP format as vendor specific IDs as otherwise related above to permit the ready movement of such information to and from the packet data serving node 10 as necessary or appropriate.

With reference again to FIG. 6, other communications destinations can couple to the Internet 61 as well as those already described. As one common example, an enterprise network 64 can couple to the Internet 61. A security gateway 64A typically effects such a coupling as understood in the art.

An illustrative embodiment will now be presented whereby the mobile node 63 can communicate to this enterprise network 64 via the second wireless communication network 62 by the auspices of the wireless gateway 10 of the first wireless communication system 11.

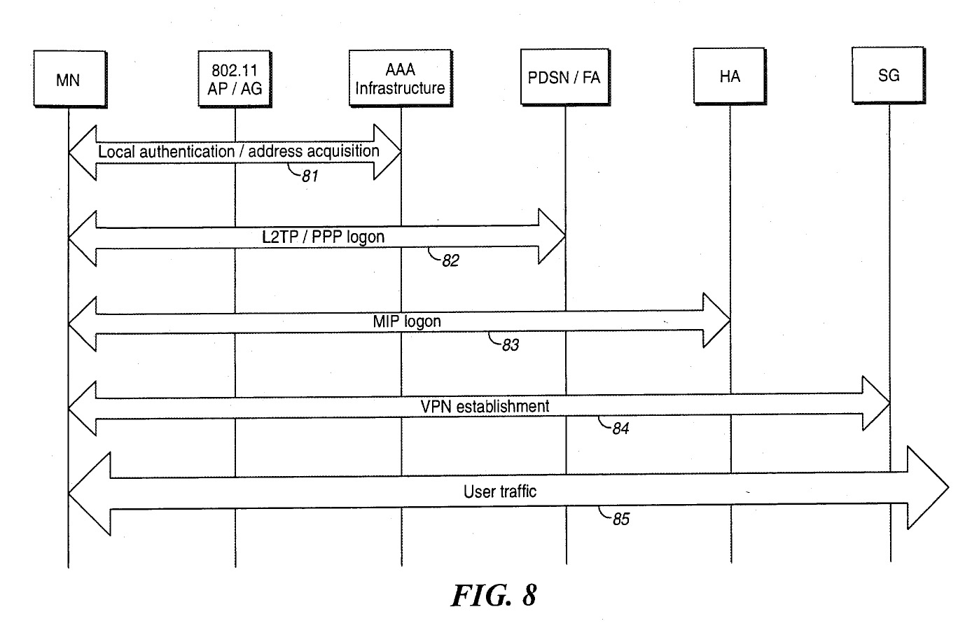

Referring now to FIG. 8, a first illustrative call flow can proceed as follows:

The mobile node (MN) 63 establishes 81 its presence on the 802.11-compatible network 62 by communicating with the authentication, authorization, and accounting (AAA) function of the second wireless communication network 62. For example, the mobile node 63 can perform a dynamic host configuration protocol (DHCP) transaction to acquire a local Internet protocol address. Optionally, the mobile node 63 may be required to authenticate itself using, for example, 802.1×, wireless Ethernet compatibility alliance standards, or geographic information systems standards as is understood in the art. Such authentication, when necessary for whatever reason, may be back-ended to the local RADIUS server 62C, which may proxy the authentication request to the home RADIUS server 11E of the first wireless communication system 11.

The mobile node 63 then establishes 82 an L2TP tunnel from itself to the packet data serving node 10 of the first wireless communication system. The mobile node 63 can acquire the packet data serving node L2TP network server Internet protocol address in a variety of ways, including any one or more of the following ways:

Static provisioning;

Static provisioning to an L2TP tunnel switch then the L2TP tunnel switch dynamically assigning a packet data serving node LNS;

Static provisioning of several packet data serving node LNS Internet protocol addresses with the mobile node 63 then choosing one of them (randomly or pursuant to some other selection scheme); or

Dynamically receiving a packet data serving node LNS Internet protocol, address in a DHCP response from the DHCP server. Once the L2TP tunnel is established, the mobile node 63 uses, in a preferred embodiment, point-to-point protocol to log on to the packet data serving node (Once the point-to-point protocol log-on is complete, the mobile node may optionally establish 83 a mobile Internet protocol session to the corresponding home agent 11D via the packet data serving node).

Once the mobile Internet protocol session is established, the mobile node 63 can establish 84 a virtual private network (preferably secure) from the mobile node 63 to the security gateway 64A as is otherwise well understood in the art, following which the desired user traffic 85 may commence. So configured, the user traffic will flow from the mobile node 63 to the 802.11 access point 62A, the access gateway 62B, the Internet 61, the carrier network 11C, and to the packet data serving node 10, which then directs the user traffic through the carrier network 11C and the Internet 61 to the enterprise network 64 via the security gateway 64A. User traffic flowing from the enterprise network 64 to the mobile node 63 would traverse, of course, an opposite path.

So configured, it can be seen that a mobile node 63 comprising a member of a first wireless communication system 11 such as a CDMA2000-compatible system can also effect wireless communications via an 802.11-compatible system via a wireless gateway 10 that comprises a part of the first communication system 11. A mobile node 63 capable of operating with such agility would then have the option of using whichever communication path were available and/or most convenient (or inexpensive) to use at any given time or location as the various systems with which this mobile node 63 operate are cooperating as described.

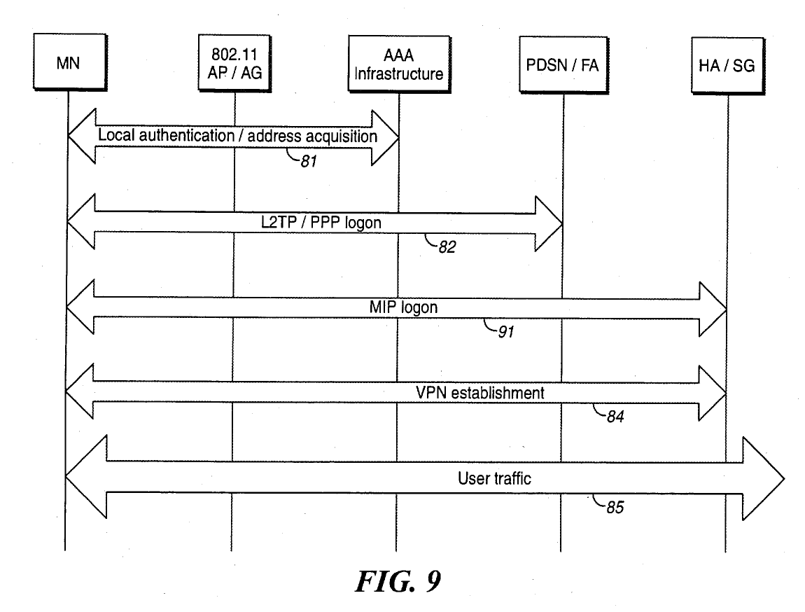

Numerous variations on such an approach are of course possible. For example, and referring momentarily again to FIG. 6, it is possible for a given mobile node 63 to comprise an enterprise user that is, by design, always anchored to the enterprise network 64. In such a case, the “home agent” for such a mobile node 63 may well reside at the enterprise (co-located with, for example, the security gateway 64A) rather than at the first wireless communication system 11. Notwithstanding such a circumstance, the wireless gateway 10 of the first wireless communication system 11 can still essentially function as described earlier. For example, and referring now to FIG. 9, an illustrative call flow could proceed as previously described with the exception that, following creation of the point-to-point protocol tunnel 82, the mobile node 63 could establish 91 the mobile Internet protocol session with the home agent as situated with the enterprise security gateway 64A.

Again, it can be seen that a mobile node 63 comprising a member of a first wireless communication system can effect wireless communications via a second wireless communication system as facilitated by a wireless gateway, such as a packet data serving node, that comprises a part of that first wireless communication system. In a preferred embodiment, the packet data serving node includes a native capability to support layer 2 transport protocol-compatible communications via an external link to an extranet such as the Internet. And, as also noted above, the packet data serving node can also serve to support various accounting activities as relate to such multi-system access usage.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A packet data serving node (PDSN) comprising a part of a first communication system and further including an extranet interface and a layer 2 tunneling protocol (L2TP) platform integrally disposed therewith, and further having a first mode of operation such that the L2TP platform supports a communication via the extranet interface.

2. The PDSN of claim 1 wherein the first communication system comprises a CDMA2000-compatible communication system.

3. The PDSN of claim 1 wherein the first mode of operation supports an L2TP-compatible communication via the extranet interface with a mobile node.

4. The PDSN of claim 3 wherein the L2TP-compatible communication comprises, at least in part, an 802.11 facilitated wireless communication.

5. A system comprising:
a first wireless communication system;
a second wireless communication system, wherein the first and second wireless communication system are at least partially incompatible with respect to supported communications protocols;
a wireless access gateway that facilitates:
user communications via the first wireless communication system as sourced by first system users within the first wireless communication system;
user communications via the second wireless communication system as sourced by first system users within the second wireless communication system.

6. The system of claim 5 wherein the first wireless communication comprises a CDMA2000-compatible system.

7. The system of claim 5 wherein the second wireless communication system comprises an 802.11-compatible system.

8. The system of claim 5 wherein:
the first wireless communication comprises a CDMA2000-compatible system; and
the second wireless communication system comprises an 802.11-compatible system.

9. The system of claim 5 wherein the wireless access gateway comprises a packet data serving node (PDSN).

10. The system of claim 9 wherein the PDSN includes a layer 2 tunneling protocol (L2TP) platform integrally disposed therewith.

11. A method comprising:
at a wireless access gateway:
facilitating wireless communications via a first wireless communications system for first system users;
facilitating wireless communications via a second wireless communications system for first system users.

12. The method of claim 11 wherein facilitating wireless communications via a first wireless communications system for first system users includes facilitating wireless communications via a CDMA2000-compatible system for first system users.

13. The method of claim 1I wherein facilitating wireless communications via a second wireless communications system for first system users includes facilitating wireless communications via an 802.11-compatible system for first system users.

14. The method of claim 11 wherein facilitating wireless communications via a second wireless communications system for first system users includes receiving a communication from a first system user seeking to establish the wireless communication via the second wireless communications system.

15. The method of claim 14 wherein facilitating wireless communications via a second wireless communications system for first system users further includes facilitating access to information resources within the first wireless communications system.

16. The method of claim 15 wherein facilitating wireless communications via a second wireless communications system for first system users further includes using the information resources to authenticate the first system user seeking to establish the wireless communication via the second wireless communications system.

17. The method of claim 11 and further comprising:
maintaining at least some accounting information regarding the wireless communications as are facilitated via the second wireless communications system for first system users.

18. The method of claim 17 wherein maintaining at least some accounting information includes maintaining information regarding at least one of:
a local Internet Protocol address as assigned to a first system user as corresponds to a given wireless communication as facilitated via the second wireless communications system;
identifying information for a corresponding second wireless communications system access point;
identifying information for a corresponding second wireless communication system access point channel;
information corresponding to signal propagation performance for the second wireless communications system as corresponds to the given wireless communication;
a hardware address as corresponds to the first system user;
information as provided by a dynamic host configuration protocol (DHCP) server as corresponds to the given wireless communication; and
a geographic location of the first system user.

19. A method to facilitate a first wireless system user communicating via a second wireless system, comprising:
the first wireless system user transmitting a first communication to a wireless access-gateway in a first wireless system using a second wireless system access point;
the wireless access gateway receiving a communication that corresponds to the first communication and determining that the first wireless system user has appropriate authorization;
the wireless access gateway at least authorizing a communication by the first wireless system user via the second wireless system.

20. The method of claim 19 wherein the first wireless system user transmitting a first communication to a wireless access gateway includes the first wireless system user transmitting the first communication to a packet data serving node (PDSN) having a layer 2 tunneling protocol (L2TP) platform integrally disposed therewith.

21. The method of claim 20 wherein the first wireless system user transmitting a first communication to a wireless access gateway further includes transmitting an L2TP-compatible communication to the PDSN.

22. The method of claim 21 wherein the second wireless system comprises a CDMA2000-compatible system.

23. The method of claim 19 and further comprising:
the wireless access gateway maintaining at least some accounting information regarding the communication by the first wireless system user via the second wireless system.

24. The method of claim 23 wherein maintaining at least some accounting information includes receiving at least some accounting information from the second wireless system.

25. The method of claim 23 wherein maintaining at least some accounting information includes maintaining information regarding at least one of:
a local Internet Protocol address as assigned to the first wireless system user as corresponds to the communication by the first wireless system user via the second wireless system;
identifying information for a corresponding second wireless communications system access point;
identifying information for a corresponding second wireless communication system access point channel;
information corresponding to signal propagation performance for the second wireless communications system as corresponds to the communication by the first wireless system user via the second wireless system;
a hardware address as corresponds to the first wireless system user;
information as provided by a dynamic host configuration protocol (DHCP) server as corresponds to the communication by the first wireless system user via the second wireless system;
a geographic location of the first wireless system user; and
communications resource usage.
